(19) United States
(12) Patent Application Publication
(10) Pub. No.: US 2024/0127325 A1
(43) Pub. Date: Apr. 18, 2024

(54) GENERATING A PRODUCT DEMONSTRATION

(71) Applicant: Walnut Ltd., Tel Aviv (IL)

(72) Inventors: Itay Adler, Givatyim (IL); Diogo Mafra Queiroga Barroso Magalhães, Patrimônio (BR); Leandro Ostera Villalva, Nacka (SE)

(21) Appl. No.: 18/173,377

(22) Filed: Feb. 23, 2023

Related U.S. Application Data
(60) Provisional application No. 63/378,560, filed on Oct. 6, 2022.

(51) Int. Cl. G06Q 30/0601; G06F 16/957; G06F 16/958

(52) U.S. Cl. CPC G06Q 30/0643; G06F 16/9577; G06F 16/986

(57) ABSTRACT

A method, product, and apparatus including: generating a demonstration of a web-based product by: recording interactive elements. An interactive element includes at least a trigger event and a layout change that results from the trigger event. The trigger event includes a user interaction with a page element of the web-based product. The demonstration is further generated by editing the interactive elements, thereby generating one or more edited interactive elements. Editing the interactive elements includes editing a feature of the interactive element. The demonstration is further generated by generating the demonstration based on the one or more edited interactive elements, and providing the demonstration to end devices. In response to identifying a user of an end device performing the user interaction with the page element, the demonstration is configured to automatically perform the layout change.

### CROSS-REFERENCE TO RELATED APPLICATION

This application claims the benefit of Provisional patent application No. 63/378,560, titled “Utilizing DOM Mutations to Preserve Interactive Functionality of DOM Documents” filed Oct. 6, 2022, which is hereby incorporated by reference in its entirety without giving rise to disavowment.

### TECHNICAL FIELD

The present disclosure relates to demonstrations of products, in general, and to creating a demonstration of a product that preserves client-side functionalities of the product, in particular.

### BACKGROUND

Web-based systems (also referred to as Software as a Service, or “SaaS”, products) are commonly used today. Such systems utilize linked documents, e.g., HyperText Markup Language (HTML), to allow the user to navigate through the system using a browser. In some cases, the browser may be an off the shelf browser (e.g., Chrome™, Edge™, FireFox™, or the like), a customized or dedicated browser, an in-app browser, a headless browser (e.g., headless Chrome™), or the like.

SaaS products may comprise a backend and a frontend, which may or may not interact with one another. In some cases, the frontend may be implemented by the browser that is executed on the user's device, displaying the Graphical User Interface (GUI) to the user. The backend may be implemented at a server, which may receive user requests from the client, and transmit responses thereto. In other cases, the backend may be implemented at least partially at a user device. In some cases, the backend may serve linked documents, such as web pages, to be presented by the browser at the client's device.

A demonstration (or ‘demo’) of a SaaS product may demonstrate one or more functionalities of the SaaS product. For example, such a demonstration may be presented as part of a sales operation, a training session for training employees to use the product, or in any other context.

### BRIEF SUMMARY

One exemplary embodiment of the disclosed subject matter is a method comprising: generating a demonstration of a web-based product, said generating comprising: recording one or more interactive elements, an interactive element of the one or more interactive elements comprises at least a trigger event and a layout change that results from the trigger event, the trigger event comprising a user interaction with a page element of the web-based product; editing the one or more interactive elements, thereby generating one or more edited interactive elements, said editing comprises editing a feature of the interactive element; and generating the demonstration based on the one or more edited interactive elements; and providing the demonstration to one or more end devices, wherein, in response to identifying a user of an end device performing the user interaction with the page element, the demonstration is configured to automatically perform the layout change.

Optionally, the layout change comprises a Document Object Model (DOM) mutation.

Optionally, the method further comprises recording a page of the web-based product that comprises the page element.

Optionally, after said providing, the demonstration is executed at the one or more end devices, wherein executing the demonstration comprises identifying trigger events that appear in the one or more edited interactive elements, and replaying respective layout changes, without executing logic functionality of the web-based product.

Optionally, the demonstration is detached from a backend of the web-based product, wherein the demonstration of the web-based product is operable in a standalone environment and without relying on communications with any external server.

Optionally, said editing the feature of the interactive element comprises one of: modifying at least one text string displayed in a textual element of a page that comprises the page element; modifying at least one color or font of an element in the page; modifying the trigger event; and modifying a visual property of the page element.

Optionally, said editing the one or more interactive elements enables customization of the demonstration for a potential client.

Optionally, said recording the one or more interactive elements comprises: monitoring page events of the web-based product; identifying in the page events the user interaction with the page element; identifying in the page events the layout change; determining that the user interaction triggered the layout change; classifying the user interaction as the trigger event of the layout change; and generating the interactive element to comprise the user interaction and the layout change.

Optionally, said monitoring is performed by a browser debugger.

Another exemplary embodiment of the disclosed subject matter is an apparatus comprising a processor and coupled memory, the processor is adapted to: generate a demonstration of a web-based product, said generate comprises: recording one or more interactive elements, an interactive element of the one or more interactive elements comprises at least a trigger event and a layout change that results from the trigger event, the trigger event comprising a user interaction with a page element of the web-based product; editing the one or more interactive elements, thereby generating one or more edited interactive elements, said editing comprises editing a feature of the interactive element; and generating the demonstration based on the one or more edited interactive elements; and provide the demonstration to one or more end devices, wherein, in response to identifying a user of an end device performing the user interaction with the page element, the demonstration is configured to automatically perform the layout change.

Yet another exemplary embodiment of the disclosed subject matter is a system comprising a processor and coupled memory, the processor is adapted to: generate a demonstration of a web-based product, said generate comprises: recording one or more interactive elements, an interactive element of the one or more interactive elements comprises at least a trigger event and a layout change that results from the trigger event, the trigger event comprising a user interaction with a page element of the web-based product; editing the one or more interactive elements, thereby generating one or more edited interactive elements, said editing comprises editing a feature of the interactive element; and generating the demonstration based on the one or more edited interactive elements; and provide the demonstration to one or more end devices, wherein, in response to identifying a user of an end device performing the user interaction with the page element, the demonstration is configured to automatically perform the layout change.

Yet another exemplary embodiment of the disclosed subject matter is a computer program product comprising a non-transitory computer readable storage medium retaining program instructions, which program instructions, when read by a processor, cause the processor: generate a demonstration of a web-based product, said generate comprises: recording one or more interactive elements, an interactive element of the one or more interactive elements comprises at least a trigger event and a layout change that results from the trigger event, the trigger event comprising a user interaction with a page element of the web-based product; editing the one or more interactive elements, thereby generating one or more edited interactive elements, said editing comprises editing a feature of the interactive element; and generating the demonstration based on the one or more edited interactive elements; and provide the demonstration to one or more end devices, wherein, in response to identifying a user of an end device performing the user interaction with the page element, the demonstration is configured to automatically perform the layout change.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows an exemplary flowchart diagram of a method, in accordance with some exemplary embodiments of the disclosed subject matter;

FIG. 2 shows an exemplary recordation process of an interactive element, in accordance with some exemplary embodiments of the disclosed subject matter;

FIGS. 3A-3D show an exemplary recordation process, in accordance with some exemplary embodiments of the disclosed subject matter;

FIGS. 4A-4B show screenshots of an exemplary indirect editing process, in accordance with some exemplary embodiments of the disclosed subject matter;

FIGS. 5A-5B show screenshots of an exemplary direct editing process, in accordance with some exemplary embodiments of the disclosed subject matter; and

FIG. 6 shows an exemplary block diagram of an apparatus, in accordance with some exemplary embodiments of the disclosed subject matter.

### DETAILED DESCRIPTION

One technical problem dealt with by the disclosed subject matter is to provide a platform for generating interactive demonstrations of web-based systems, products, or the like (referred to herein as the ‘product’), that do not rely on a real time execution of the product. For example, one or more companies may desire to generate demonstrations (‘demos’) of their web-based products, Software as a Service (SaaS) products, or the like, and to provide such demos to potential clients. In some exemplary embodiments, providing a demo to potential clients may enable the potential client to grasp the capabilities of the demonstrated product, without purchasing or having access to the product itself. In some exemplary embodiments, an interactive demo may refer to a demonstration of the product that demonstrates to an end user the functionalities and capabilities of the product while providing similar user experience (UX) but without having access to the actual product.

In some cases, demonstrating capabilities of the product using the product itself, such as by executing one or more functionalities of the product, may be disadvantageous, at least since the product may exhibit a bug while the demo is shown, may exhibit sensitive information, code thereof may be copied, provide unpredictable or inconsistent results, or the like. For example, a demonstration that uses the backend of the product for its execution, may not function properly in case that the backend of the product has a temporarily crashed. In such a case, the demo may not respond to a query sent from the frontend, thus not fulfilling the desired role of a demo. As another example, a demonstration that uses the backend of the product for its execution, may reveal sensitive information, such as by presenting sensitive information of clients in response to a query of the salesperson. As yet another example, a demonstration that uses the actual logic of the product for its execution may have potential harmful implications to the product, such as allowing end users to issue “delete” instructions that can delete data in the production environment. As yet another example, recent changes in the user interface or functionality of the product, may interrupt the flow of the demonstration, such as the case that a salesperson presents the demo to potential clients and is unable to find a new location of a button that was recently moved. It may be desired to provide a demo of a product without relying on a real time execution of the product itself, such as in order to overcome the drawbacks enumerated above.

It is noted that while the present disclosure relates to “web-based” products, systems, or the like, such systems may be implemented without the use of the World Wide Web (WWW), and instead be implemented using on-premises local network, such as in the case of a company that retains a separate infrastructure, who may prefer to limit accessibility to the Internet.

Another technical problem dealt with by the disclosed subject matter is to provide a customization of a product demo. In some cases, a company may wish to demonstrate its product while enhancing a presentation of the product to match preferences of a potential customer. For example, the salesperson of the company may wish to change colors of product features, logos, or any other visual features of the web-based product. In some cases, it may be desired to provide a demo-generating platform that enables employees of a company, such as the salesperson, to perform changes to the layout of the demo, without affecting customers of the company's product. For example, the salesperson of the company may wish to change a color of the product pages in a demo that is provided to a potential client, without affecting a color of the product itself for any customers that use the actual product. As another example, the salesperson may wish to change data points used by the product, such as by changing names shown in the product pages from real names to dummy names, removing financial values from product pages, or the like. Such customization may be desired to be performed without requiring changes in a data repository of the product, e.g., at a backend thereof.

Yet another technical problem dealt with by the disclosed subject matter is to provide an authentic demonstration of a product. In some exemplary embodiments, in order for a demo to represent the product in an authentic manner, it may be desired that the demo will support at least some of the possible user interactions on a web page such as drop downs elements, tooltips elements, menu elements, or the like. For example, enabling such elements may demonstrate in an authentic manner how the product can be used, and may exhibit the user experience (UX) provided by the product.

Yet another technical problem dealt with by the disclosed subject matter is to provide the authentic demonstration of the product, without relying on logic code of the product. In some exemplary embodiments, some of the logic may be implemented by a client-side code of the product. For example, the client-side code of the product may be configured to identify page events, and communicate in response queries with the backend, such as in order to fetch data to be presented to the user. In some cases, a demo of a product that relies on the client-side code may have one or more drawbacks, at least since executing such code may have undesirable side effects, and since utilizing such a code without contacting the backend may require extensive modifications of the client-side code, and may yield unpredictable or inconsistent results.

One technical solution provided by the disclosed subject matter is providing a platform that enables operators of the platform to record desired portions of their product, and to generate based thereon a demo that enables to replay the recorded portions. In some exemplary embodiments, the demo-generating platform may comprise a software agent that may be executed on a user device while the actual product is executed or rendered on the user device. In some exemplary embodiments, the software agent may be configured to identify page events, record them for a demo, and enable replaying them. For brevity, the software agent may be referred to as the ‘agent’.

In some exemplary embodiments, an operator may obtain the software agent, and utilize the software agent to create a demo of a web-based product. In some exemplary embodiments, the software agent may be initialized, or activated, by an operator that wishes to create a demonstration of a product. For example, an operator may comprise a user of an end device that wishes to create a demonstration of a product, and may obtain a demo-generating platform in the form of the agent. In some exemplary embodiments, in order to utilize the software agent for recording portions of a session with the product, the operator may launch and execute the product. In some exemplary embodiments, the agent may comprise a software tool, or software layer, or the like, that may be executed over the product and may enable the operator to start a recordation of a session, pause a recordation, terminate a recordation, or the like. In some exemplary embodiments, the recording may be triggered by a human operator, an artificial operator, or the like, such as based on a command to record interactions of the operator, e.g., via a command line, a vocal command, a selection of a GUI element, or the like.

In some exemplary embodiments, during an activated recordation of the session, changes to the display that occur in response to user interactions may be identified, determined, or the like, and recorded to enable a replay thereof. In some exemplary embodiments, the software agent may record pages, screens, computer displays, or the like (referred to herein as ‘pages’ or ‘screens’), of the product to which the operator navigates, user interactions of the operator with the pages, changes to the display, and the like. In some exemplary embodiments, one or more user interactions that result with respective display changes may be referred to, together, as an ‘interactive element’, and may be recorded and potentially edited. For example, an interactive element may include a “mouse-hover” event together with a Document Object Model (DOM) mutation that, when applied on a page, create a desired change in the page. In such an embodiment, once the mouse-hover event is identified, the DOM mutation may be applied to replay the same GUI update that occurred in the system. In some exemplary embodiments, the software agent may store, in association with one or more recorded screens, respective interactive elements that can be replayed by end users.

In some exemplary embodiments, interactive elements may or may not be edited, such as in order to customize the demo to potential clients, to anonymize the data in the demo, to enhance a visual appearance of the demo, to enhance a presentation of the demo, or the like. In some exemplary embodiments, a demo may be created based on the edited interactive elements, and may be published and made available to end users. For example, the demo may be created by presenting a captured screen, and replaying display changes in response to interactions of the end users with the demo.

In some exemplary embodiments, the software agent may utilize a capturing tool in order to capture pages or screens of the product (e.g., web pages), to capture DOM changes, to capture user interactions with the pages, to capture page events, or the like. For example, the capturing tool may capture HyperText Markup Language (HTML) documents of the product, e.g., using a browser extension, a desktop agent, a combination thereof, or the like. Additionally, or alternatively, the capturing tool may capture dynamic HTML modifications by using a browser debugger. In some cases, the software agent may capture a user interface of the product including a displayed portion thereof, HTML files of the product, JavaScript files of the product, CSS files thereof, attached images, browser extensions, or the like, without necessarily communicating with an Application Programming Interface (API) of the product, with a backend thereof, or the like. In some exemplary embodiments, the capturing tool may capture trigger events that relate to user interactions, dynamic page modifications, or the like. In some exemplary embodiments, the capturing tool may record the relative order between trigger events and page modifications.

In some exemplary embodiments, the software agent may utilize such capturing capabilities to reconstruct traces that begin with user interactions with a page, and end with layout changes on the page. Such traces may be recorded and replayed in the demo. In some exemplary embodiments, in order to create a demo that preserves at least a portion of the client-side functionality of the product, the agent may differentiate between one or more interactions of the operator with a page of the product (‘trigger events’ or ‘triggers’), and between Document Object Model (DOM) mutations or other changes occurring to a layout of the recorded page in response to the triggers. In some exemplary embodiments, the DOM mutations may refer to any changes to a DOM tree representing a page, such as an HTML page, a web page, a mobile app page, or the like.

In some exemplary embodiments, the software agent may obtain screens and page events from the capturing tool, and classify the page events to triggers and results. In some exemplary embodiments, a trigger may comprise one or more interactions with the page that initiate processes that cause changes to the layout, display, User Interface (UI) of the page, or the like. For example, triggers may comprise page events such as clicks, vocal commands, mouse-enter operations, mouse-leave operations, mouseover operations, mouse-out operations, or the like. In some exemplary embodiments, the software agent may identify captured user interactions as triggers that cause layout changes, such as DOM mutations.

In some exemplary embodiments, the agent may be configured to correlate between triggers and layout changes, such as based on heuristics, rules, or the like. For example, the correlation may be based on monitored user interactions, on occurrence time of each interaction, an occurrence time of layout changes, a stack trace analysis, or the like. In some cases, triggers and resulting DOM mutations may be identified by a debugger logic that can be used to analyze which element changes are caused as part of an executed code that is triggered by a specific page event. For example, the debugger logic may monitor a page event, determine that the page event is a potential trigger, and analyze DOM mutations that occur as part of a code execution of the page event. According to this example, such DOM mutations may be correlated, or associated, with the identified trigger.

In some exemplary embodiments, triggers and respective layout changes may be stored as an interactive element, such as in a local or remote data repository of the demo. In some exemplary embodiments, once a layout change is recorded after a trigger, all subsequent layout changes may be stored under the same interactive element. For example, a user click that caused multiple changes in the DOM may be stored as a single interactive element. It is noted that changes to the DOM, or other layout changes, that did not stem from the originating trigger, may not be included in the interactive element, and will not be replayed in the demo in response to activation of the trigger. In some exemplary embodiments, tying together one specific user interaction to the corresponding layout changes, or DOM mutations, generated by it, may be challenging. For instance, in case the operator performs both a resolved promise (e.g., a Promise.resolve( ) method) and a click on a dropdown during a same second, it may be necessary to distinguish between mutations generated by each trigger. In some exemplary embodiments, a browser debugger may be utilized to distinguish between mutations generated by each trigger in a manner that is not time-sensitive, such as by gathering data from event handlers, and detecting the mutations generated by them, thus separating the monitored events to respective ordered interactive elements.

In some exemplary embodiments, a single interactive element may include any triggers and respective changes that are dependent on each other. For example, in case a trigger causes a new element to appear, the new element may be considered to be dependent on the trigger. As another example, in case that a first interaction with a page element can only be performed after performing a second interaction with the page element (e.g., hovering on the element before clicking on the element), the first interaction may be considered dependent on the second interaction. In other cases, any other dependency rules may be used. In some exemplary embodiments, an interaction that is performed over results of a previous interactions, or that is dependent in any way on the previous interactions, may create a single independent interaction element that comprises all the dependent components. For example, in case a first trigger causes a first element to appear in the layout, and a second trigger is performed by interacting with the first element, then the second trigger may be determined to be dependent on the first trigger, and may be retained in the same record of an interactive element. As another example, a first interactive element may be generated to include the first trigger and the respective layout changes, and a second interactive element may be generated to include both the first and second triggers, and their respective layout changes. In other cases, any other number of triggers and respective changes may be stored in a record of an interactive element. In other cases, relations between interactions may be represented by a dependency tree, which may reduce the number of duplicate information that is stored in the demo's data repository.

In some exemplary embodiments, a captured page, such as an HTML page, may be retained in the data repository of the demo together with a list of respective interactive elements that were captured in the page. For example, the captured interactive elements that were captured within the page may be stored as interactive elements of the page, and may be presented to the operator in an editor mode of the demo-generating platform, e.g., in an overlaying menu element. In some cases, a same interactive element may be stored with multiple captured pages, such as in case that the interactive element fully appears in each of the multiple captured pages. In such cases, the data repository of the demo may retain the interactive element in association with the multiple captured pages. For example, metadata or indications of the association may be retained in the data repository.

In some exemplary embodiments, the recording of the product session for the demo may be continuous, semi-continuous, discrete, or the like. For example, in a continuous mode, the software agent may continuously record any page events that include interactions of the operator with the product, display changes, or the like, and also capture navigations to other pages of the product. In some exemplary embodiments, during a continuous capture mode, every user-initiated event, such as a click, may result with a new interactive element, and may be automatically retained in association with the respective page. Upon the operator navigating to a new page of the product, the new page may be captured, and any page events in the new page may be retained in association with the new page. In some cases, a navigation to a new page of the product may be detected by a change of Uniform Resource Locator (URL), a domain change, or the like. As another example, in a semi-continuous mode, the software agent may record page events for a defined number of operations (e.g., a single interactive element), a defined number of pages, or the like. For example, the semi-continuous mode may comprise recording page events until navigating away from the page, and may require the operator to activate the recording process every time that a new page is reached. As another example, in a discrete mode, the operator may be required to initiate a recordation separately for each interactive element.

In some cases, the recording process may be paused and continued according to commands of an operator, indicating which portions of the session are intended to be included in the created demo. For example, in order to omit one or more operations or changes from the demo, the operator may select to pause the recording process, such as by clicking on a ‘pause’ button. In some exemplary embodiments, a selection of a recordation mode may be made, such as in order to select whether the recordation mode should include the continuous mode, the semi-continuous mode, the discrete mode, or the like. For example, the operator may select a capturing mode via the UI. In some cases, a continuous mode may be selected when trying to emulate as much data as possible from the product, to be included in the demo. For example, in some scenarios, the operator may desire to emulate a large number of pages and associated interactive elements from the product, and thus the continuous mode may be used. In some cases, a semi-continuous mode or discrete mode may be used when precision and curation are preferred by the operator over quantity of data. For example, in case not all screens, or interactions, would be useful in a demonstration of a product.

In some exemplary embodiments, after capturing one or more screens and respective interaction elements, and storing them in the data repository of the demo, an editing process may be performed. In some exemplary embodiments, the editing process may enable the operator to edit the captured interactive elements, page elements or properties that are not included in an interactive element (the ‘base screen’), or the like. In some exemplary embodiments, elements may be edited such as by modifying text thereof, modifying colors or fonts of elements, adding or linking a different screens or GUI element to an existing element, or the like.

In some exemplary embodiments, in every captured page, a menu, or any other visual tool, may be deployed to the operator in order to enable to the operator to edit the captured interactive elements. For example, interactive elements that are associated with a page may be presented in a similar manner to screen edits. In case of an interactive element that comprises a sequence of interactive pairs, each pair including a trigger and a resulting DOM change, the entire sequence may be presented, or played, simultaneously, to be edited. In some case, while in edit mode, the agent may render an overlay that include a tool, or a menu, that presents the interactive elements of the page, and enables to render the interactive elements in the associated page. In other cases, the operator may be enabled to directly edit interactive elements in the page, such as by clicking on the desired element and instructing the editor to play the associated interaction.

In some exemplary embodiments, after editing one or more properties of the captured screens and/or interactive elements, the demo may be created, generated, or the like. For example, the demo may be created based on the edited interactive elements. In some exemplary embodiments, the demo may be published, provided to one or more end users, or the like. In some exemplary embodiments, the end users may be enabled to interact with the demo, during a replay stage, and to thereby grasp the capabilities of the demonstrated product.

In some exemplary embodiments, during the replay stage, an end user may perform one or more interactions with one or more edited or non-edited recorded pages of the demo, thereby activating respective interaction elements that are retained for each page. Such interaction elements may or may not be edited. In some exemplary embodiments, edited interactive elements may be replayed in their edited form, e.g., in response to the respective triggers. In some exemplary embodiments, replaying the interactive elements may comprise monitoring user interactions with a page, detecting that a trigger event was performed, and replaying the respective layout changes that are comprised in association with the trigger within the respective interactive element. In case of an interactive element that comprises a sequence of multiple interactive pairs, each pair including a trigger and one or more resulting DOM changes, the first pair may be activated in response to identifying the respective trigger, the second pair may be activated in response to identifying subsequently the second trigger, and the like.

In some exemplary embodiments, an end user interacting with the demo may not necessarily be aware that the demo is ‘shallow’ (e.g., detached from the backend of the product), or that the interactions comprise a replay of recorded and/or edited layout changes. In some cases, the experience of interacting with pages of the demo may be seamless for end users, at least since client-side functionalities may be at least partially restored, and user interactions with demo pages may trigger expected DOM mutations, thereby emulating the experience of an interactive web page.

One technical effect of utilizing the disclosed subject matter may be creating a demo that is detached from the product, and does not rely on client-side code of the product. During execution, the detached demo may provide end users with a dynamic functionality without relying on the product or executing the product in real time. Since the demo may be detached from the product's backend, the demo may function properly even during down-times of the backend, regardless of introduction of new bugs in the development environment, without relying on a functioning production environment, or the like. Additionally, since the demo may be detached from the product's backend, potentially harmful interactions with the demo, such as a deletion of elements, may not affect a backend of the product, and thus may not delete any records of the product's database.

Another technical effect of utilizing the disclosed subject matter may be enabling an operator to create a demo of any desired web-based product in a customizable manner, using the edit phase, such as in order to enable the operator to implement the demo without exposing sensitivity client data, while still enabling a display of real-life scenarios that are based on real data.

Yet another technical effect of utilizing the disclosed subject matter may be generating a demo of a product that provides an interactive client-side functionality, although it is detached from the product's backend and does not rely on client-side code of the product. In some exemplary embodiments, instead of relying on client-side code of the product (e.g., which utilizes backend queries to provide a client-side functionality) to preserve a client-side functionality thereof, the client-side functionality may be preserved based on a recordation of user interactions with the product, and changes to the display that occur in response to user interactions. Although the client-side code of the product may not be used, the user experience of interacting with pages of the demo may be preserved, and seamless, by emulating the experience of an interactive web page. In some exemplary embodiments, the detachment of the demo from the product may enable the demo to be created for any product without requiring communications or access to a backend of the product, by recording screens and interactions with the frontend of the product.

Yet another technical effect of utilizing the disclosed subject matter may be to create a detached demo that preservers a client-side functionality, in a resource conserving manner. For example, a naïve method of creating a detached demo may comprise capturing a plurality of snapshots of a same page after employing different client-side functionalities, and connecting shallow-copies of such versions of the page. Such a method may be resource consuming, in contrast to the disclosed subject matter, which utilize less storage space by recording a single page for multiple interactive elements. Utilizing recorded interactive elements may be advantageous with respect to utilizing full page snapshots, also since interactive elements may be modified with ease, such as by editing interactive elements of a page, or replacing a screen that is associated with multiple interactive elements. For example, in case a title of a page is modified, the modified version of the page may be stored with the same interactive elements as the previous version of the page, without requiring to modify multiple versions of the same page.

Yet another technical effect of utilizing the disclosed subject matter may be to generate a demo of a product that is operable in a standalone environment and without relying on access to any remote resource. In some exemplary embodiments, the execution of the demo may rely on the data repository, which may be stored locally or in remote. In case the data repository, or a representation thereof, is stored locally on a computing device, the demo may be executable on the computing device in an offline manner, in a system having no network connectivity, enabling the demo to be displayed to government agencies and other entities having a restrictive network guidelines. The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

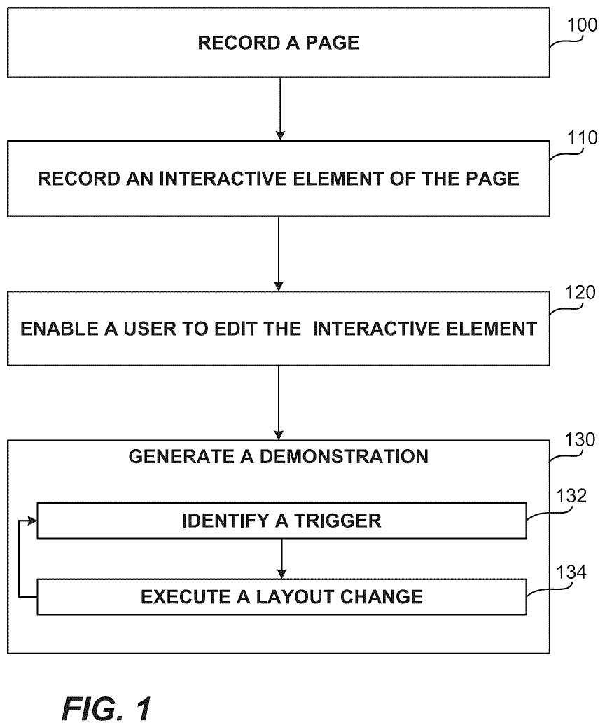

Referring now to FIG. 1 illustrating a flowchart diagram of a method, in accordance with some exemplary embodiments of the disclosed subject matter.

On Step 100, a page of a web-based product may be recorded, captured, or the like, thereby obtaining a recorded page. For example, the page may be recorded by a demo-generating platform that is configured to generate a demonstration of a web-based product. In some exemplary embodiments, the recorded page may constitute an HTML page, a web page, an XML file, or the like. In some exemplary embodiments, the recorded page may comprise one or more page elements. For example, the product may be executed, causing a webpage to be transmitted by the backend of the product to the frontend to the product, such as using HyperText Transfer Protocol (HTTP). According to this example, recording the webpage may comprise copying HTML code of the webpage, CSS code thereof, images thereof, page elements thereof, or the like, which may represent the page. In other cases, recording the webpage may comprise adding to the page JavaScript code that is configured to identify events that invoked DOM mutations in the page, and adding for each such event, a code that invokes the relevant DOM mutations.

In some cases, the product page may comprise client-side code that is configured to provide a dynamic functionality in response to user interaction therewith. For example, the page may comprise JavaScript code that is executable by a browser displaying the page, to perform a dynamic functionality. In some cases, the dynamic functionality may be local, such as in case of collapse/hide functionality, or may rely on a remote resource, such as in case of a functionality that is dependent on dynamic data retrieval. In some exemplary embodiments, the client-side code may not be recorded by the agent, and thus may not be included in the recorded page. In other cases, the client-side code may be recorded and at least partially removed from the recorded page at a subsequent step.

In some exemplary embodiments, the software agent may comprise a desktop agent, a desktop Software Development Kit (SDK), a browser extension, a debugger, a browser debugger, a combination thereof, or the like, and may be locally deployed in a computing device that is capable of executing the frontend of the product. For example, a browser debugger may enable to test web-based product over desired browsers and Operating Systems, and may be stored on-premise, on a cloud, or the like. In some cases, the browser debugger may be managed in the background, in an action script, or the like, and may be initialized, e.g., by enabling relevant Application Programming Interfaces (APIs), such as DOMDebugger, Debugger and the Runtime APIs, which may be utilized to gather the necessary information to tie a specific event to its generated mutations. However, unless otherwise stated, the agent may be implemented using other non-debugging tools. In some exemplary embodiments, the software agent may comprise one or more capturing tools for capturing pages and interactive elements of the product, an editor for editing such captured features, and a generator for generating a demo from the captured features.

In some exemplary embodiments, the software agent may deploy one or more capturing tools in order to capture screens or pages of the product, e.g., as an overlay over the product execution. In some exemplary embodiments, the operator may browse through several pages of the web-based product, and the capturing tools may be executed over the product and capture each such page. In some exemplary embodiments, the software agent may record one or more pages, screens, or the like, of the product, e.g., using the browser debugger.

In some exemplary embodiments, the capturing tool may comprise any software tool that is capable of capturing features of the product. In some exemplary embodiments, the capturing tool may be configured to have capturing capabilities that enable to capture product pages, as well as associated user interactions with the pages, user events, DOM mutations (e.g., including changes to the DOM tree), or the like. For example, the capturing tool may comprise a browser debugger that is configured for debugging web-based systems (e.g., Chrome™ debugger), which may allow operators to debug websites online directly through web browsers. For example, the agent may define one or more breakpoints in the code of the product pages, which may enable the debugger to examine current variables, execute commands in the console, or the like.

In other cases, the software agent may comprise any other capturing tool, such as an instrumentation tool that implements some of the functionalities that are implemented in the debugger. For example, the capturing tool may comprise a browser, a browser extension, or the like. As another example, the capturing tool may comprise a desktop agent, which may be executed in parallel to the frontend of the product (e.g., a web browser, a headless browser, an in-app browser, a native application, or the like). The desktop agent may be configured to monitor activity of the product's frontend and obtain relevant information therefrom. As another example, the capturing tool may comprise a dedicated fetching website. In some exemplary embodiments, the fetching website may be configured to present the product pages and to monitor interactions therewith, requests and responses associated therewith, or the like. For example, the fetching website may present the product in an inline frame (iframe) element, and, through the use of an API of the iframe element, the fetching website may monitor retrieved pages, user interactions, requests and responses, or the like, associated with the product, thereby enabling the operator to capture specific portions of the product. As yet another example, the capturing tool may comprise an automated bot, configured to mimic user interaction with the product in an automated manner, such as by deploying a web crawler.

In some exemplary embodiments, the software agent may store a copy of one or more pages of the product in a data repository of the demo. For example, the data repository of the demo may be generated and deployed locally, in the same computing device that executes the agent, remotely, such as in a cloud, or the like. In some exemplary embodiments, a recorded page that is stored in the repository may comprise a shallow copy of the page of the product, that includes merely the displayed screen of the product, HTML code thereof, or the like. For example, in contrast to the original product page, the recorded page may not be linked to other pages, and may not comprise client-side code that can be executed by the browser.

On Step 110, one or more interactive elements of a product page may be captured, recorded, or the like, as part of generating the demonstration. For example, the interactive elements may be captured by a same capturing tool that captured the product page, by different capturing tools, or the like. In some exemplary embodiments, Step 110 may be performed after each page is captured by Step 100, such as in an interleaved manner.

In some exemplary embodiments, recording the one or more interactive elements may comprise monitoring page events of the web-based product. In some exemplary embodiments, monitoring the page events may be performed by a browser debugger. For example, the browser debugger may utilize one or more breakpoints in order to detect user interactions with the page and subsequent layout changing events, e.g., DOM mutations. In other cases, monitoring the page events may be performed by any other capturing tool. In some exemplary embodiments, in case a browser debugger is used, instead of testing the product, the debugger may be utilized to gather data from event handlers and the mutations generated by them.

In some exemplary embodiments, an interactive element of the one or more interactive elements may comprise at least a trigger and a layout change that results from the trigger. In some exemplary embodiments, the trigger may comprise a user interaction with a page element of the web-based product. For example, triggers may comprise a click on a page element, hovering over a page element, or the like. In some cases, a recordation of a trigger may comprise properties of the trigger such as a name of the page event, a relative location in the page of the page element, a type of the page element, or the like.

In some exemplary embodiments, the layout change may comprise a DOM mutation, and may be recorded similarly to the trigger. For example, the layout changes may comprise, for example and without limitation, collapse-expand functionality, in which sets of items are hidden from view (collapse) or made visible (expand); dynamic tooltips that are dynamically loaded upon hovering or selecting a page element; dynamic feed or infinite feed functionality, in which additional items are dynamically loaded when a user approaches an end of screen and added to the feed element; dynamic ‘accordion’ presentation before a target item is loaded; dynamic graph animation; dynamic table functionality, in which additional rows and columns are added in response to user interaction; dynamic charts functionality, in which a snippet of a chart is shown and additional snippets can be viewed when the user slides to different areas in Y-axis and X-axis values; map widget functionality, enabling the user to zoom in and out, pan to different geographical areas and add/remove map layers (e.g., satellite imagery layer, terrain layer, traffic layer); drag & drop functionality, in which the frontend responds to dropped items and performs a functionality defined in the linked document with respect to the dropped items, such as by uploading the items to a server, enabling dynamic editing of the items, or the like. It is noted that the above are merely examples and the layout change may comprise any other client-side functionalities.

In some exemplary embodiments, in order to identify the triggers and the resulting layout changes, the recorded page events may be analyzed, to identify user interactions with the page element and layout changes. In some exemplary embodiments, in case a user interaction is determined to be a trigger that triggered the layout change, the user interaction may be classified as a trigger. In such cases, the agent may generate an interactive element that comprises the user interaction as a trigger, and the layout change as an expected outcome thereof.

In some exemplary embodiments, the agent may distinguish between mutations generated by each trigger, such as by utilizing breakpoints of a browser debugger. In some cases, breakpoints may be added to events that are associated to user interactions (clicking, hovering over, or the like), and all the page events between first and second breakpoints may be affiliated with a trigger that includes the event of the first breakpoint. For example, breakpoint may be added to hover and clicking events, and page events that occur after hovering over an element and prior to clicking on the element may be determined to be caused by the hovering operation. For example, a script may be injected in the product page to observe all mutations that happened on the page, and cause every DOM mutation that occurs on the page to hit a debugger breakpoint. As a result, every time that a DOM mutation occurs, the debugger may be invoked. As another example, breakpoints may be set for events of interest, such as click events, ‘mouseenter’ events, ‘mouseleave’ events, ‘mouseover’ events, ‘mouseout’ events, or the like. As a result, every time that the operator interacts with the page and an event of interest is captured, the debugger may be invoked.

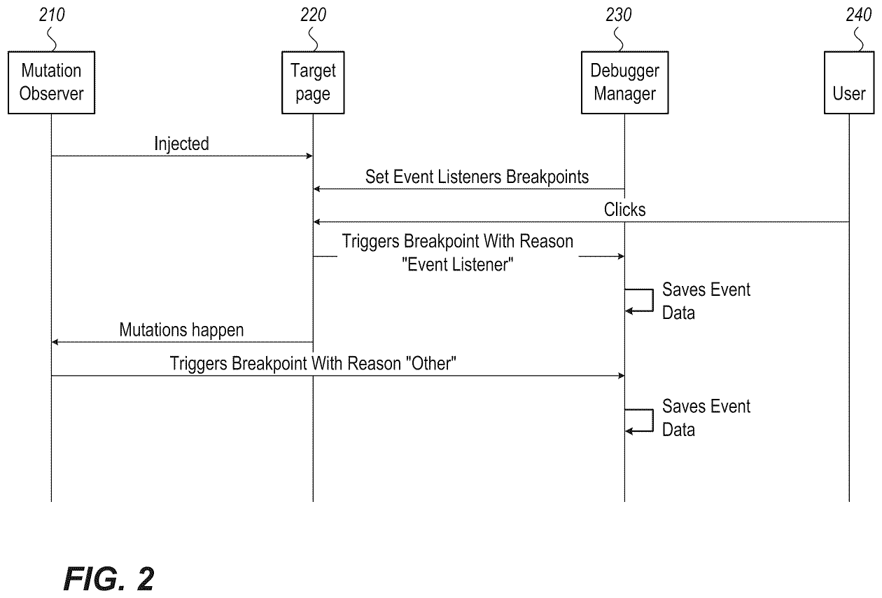

In some cases, such as in the scenario depicted in FIG. 2, an event listener breakpoint may be added to the debugger. In some exemplary embodiments, it may be expected that when the operator performs a trigger (e.g., an action that triggers a layout change), the event listener breakpoint that was added will get triggered before executing the event handler function of changing the layout. Thus, before executing the layout change, the agent may be within the event handler's scope, and may have access to the call frame Identifier (ID) which allows to evaluate code in that call frame, thus determining the trigger of the layout change. In some exemplary embodiments, once the event data is gathered, including page elements that are associated with the triggers, the page elements may be stored as a trigger of an interactive element, alongside with properties of the trigger, e.g., from the event handler function. After pausing on the event listener breakpoint, the code may continue to run, possibly mutating the DOM of the page. In some exemplary embodiments, in case the DOM is mutated, the injected script which observes all the mutations is triggered and hits a breakpoint, and the mutations in this scope may be collected and added to the interactive element. It is noted, however, that other heuristics or rules can be applied to correlate between events and mutations.

In some cases, the page events between the first and second breakpoint may include an undesired element, such as dynamically changing page elements (e.g., a timer) that do not stem from the trigger. Such dynamically changing elements may be removed from the respective interactive element, such as by analyzing the page to identify dynamically changing page elements, and removing them from interactive elements. In other cases, such dynamically changing elements may be removed, such as by the operator on Step 120.

In some exemplary embodiments, interactive elements may be stored, within the data repository, in association with a recorded product page. For example, the software agent may store, in a repository of the demo, a copy of one or more pages of the web-based system, and for each such copy, one or more recorded interactive elements. As another example, the software agent may store a single interactive element for multiple pages, e.g., in case that the interactive element appears in the multiple pages. In some exemplary embodiments, the interactive elements may be stored and re-used to when playing the demo, previewing the demo, editing the demo, or the like.

In some exemplary embodiments, interactive elements and/or pages of Step 100 may be recorded as part of a continuous mode, a semi-continuous mode, a discrete mode, or the like. For example, during a discrete mode, a single interactive element may be captured for each user instruction. In such cases, the agent may capture the underlying page, and then the operator may be provided with a possibility to add an interactive element to the page, e.g., via a page widget or tool provided by the agent. In some exemplary embodiments, during a continuous mode, a plurality of pages and interactions therewith may be captured continuously, such as in one swift motion. In some exemplary embodiments, during the continuous mode, any navigation to a page of the product may cause the agent to capture the page, and any triggers and respective layout changes may be recorded as an interactive element of the currently rendered page. In some exemplary embodiments, in a semi-continuous mode, the capturing of interactive elements may continue until the URL, or other domain or address of the page, changes, at which point the agent may capture the subsequent page.

On Step 120, the operator may be enabled to edit one or more recorded interactive elements, e.g., in order to generate the demonstration. For example, the agent may deploy a screen editor that may enable to edit the captured screens, recorded interactive elements associated with the screens, or the like. In some exemplary embodiments, editing the recorded pages may cause a generation of new edited pages (e.g., new HTML pages), or may cause the original recorded pages to be modified. A user may select a page element to be edited in any way, such as via a vocal instruction, via a click, via an eye tracking device, or the like.

In some exemplary embodiments, editing the interactive elements, the base screens, or the like, may enable to customize the demonstration for a potential client, e.g., according to preferences of the operator, of a represented organization, or the like. In some exemplary embodiments, the customization of the demo may comprise, for example, changing text of an interactive element, changing a displayable string of an interactive element, changing a color of an interactive element, changing font properties (e.g., color, size, style, or the like) of a string in an interactive element, changing visual properties of page elements that are not interactive element, such as replacing a picture shown in the page, or the like.

In some exemplary embodiments, editing the one or more interactive elements may generate one or more edited interactive elements. In some exemplary embodiments, editing an interactive elements may comprise editing one or more features of the interactive element. For example, a feature of an interactive element may comprise a text string displayed in a textual element of the page, a color or font of an element in the page, an event associated with the trigger (e.g., the trigger event), a visual property of the page element, or the like.

In some exemplary embodiments, in addition to or instead of editing the interactive elements, the operator may be enabled to edit base screens, which comprise portions of the recorded page and page elements thereof that are not part of a recorded interactive element. For example, in case a page includes multiple text fields, and the demo is generated by performing interactions with a first text field and not with a second text field, the editing stage may enable the operator to edit properties of the second text field. For example, in case a property of a base screen is edited, such as by changing a background color thereof, the data repository may replace the page with the edited page, or add a copy of the edited page to the repository and store metadata indicating that the edited page should be used instead of the original page.

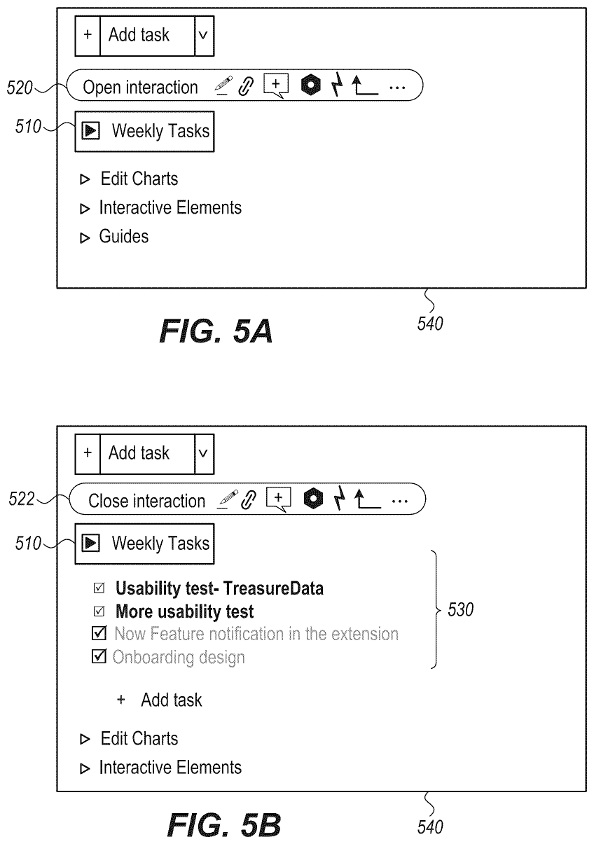

In some cases, in order to edit a recorded page, the agent may deploy an editor platform, a screen editor, or the like, which may present the recorded pages to an operator. The editor may comprise a desktop application, a website, or the like, that may enable to load a data repository with recorded pages and interactive elements, and to edit such data. For example, as depicted in FIG. 5A, the operator may edit an interactive element of a page by directly selecting a page element within the page, and selecting an ‘Open Interaction’ element from a menu of options associated with the page element, which may cause the interactive element to be ‘played’, or fully presented on the screen. Fully presenting an interactive element, or playing thereof, may refer to presenting the element of the trigger (a page element with which the user interaction is performed) and the resulting DOM mutations.

In some cases, playing the interactive element creates a new open state that can then be edited, e.g., as depicted in FIG. 5B. In some exemplary embodiments, the open state of the interactive element may enable properties of the interactive element to be edited, such as by adding to the interactive element new text and images, replacing text of the interactive element with new text, causing the interactive element to become a target of a guide, linking the interactive element to other screens, or the like. In some exemplary embodiments, once the editing process of a page element is completed, such as in case that the operator does not wish to edit any other property of the element, the operator may select to close the editing of the element, such as by selecting a ‘Close interaction’ element in FIG. 5B. The operator may be enabled to edit any other page elements of any other captured screens.

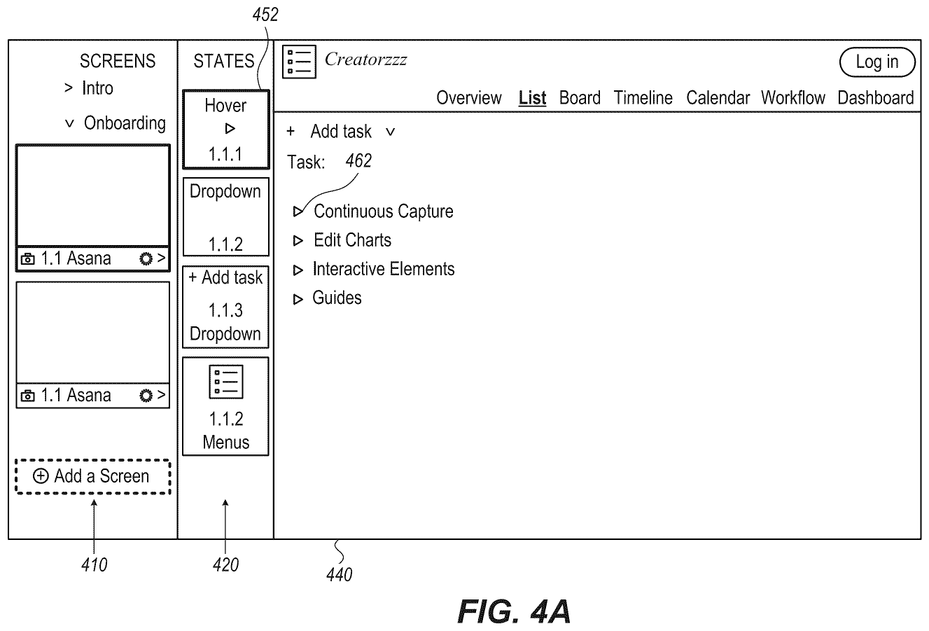

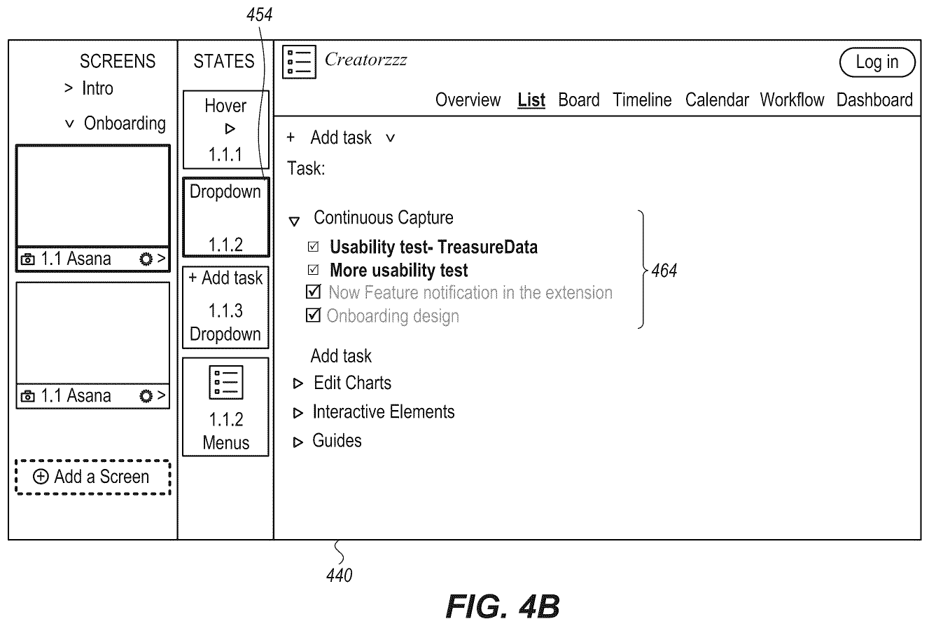

In some exemplary embodiments, instead or in addition to editing interactive elements directly within a page, the editing process may comprise editing interactive elements of the page indirectly, such as via a dedicated menu or toolbar. In some exemplary embodiments, in order to enable the operator to edit the interactive elements of a page, a secondary menu may be added (e.g., a ‘States’ side menu of FIG. 4A), through which the user may be enabled to select any of the captured interactive elements and edit them. For example, the interactive elements may be represented using one or more GUI elements, thus providing the operator with access to editing interactive elements from a screen side menu, e.g., as depicted in FIGS. 4A-4B, instead of editing the interactive elements directly from the page. In some exemplary embodiments, upon selection on an interactive element via the menu, the selected element may be played on the screen, presenting the state that can now be edited.

In some cases, a selection of an interactive element from the menu, or directly from the page, may or may not cause associated elements in the screen that are affected by the element to be visually marked, indicated, or the like. For example, Dropdown Element 464 in FIG. 4B may be presented and marked upon selecting Dropdown State 454. In some cases, such as in the scenario of FIG. 4A, relations between interactions may be represented by the secondary menu (e.g., the ‘States’ side menu of FIG. 4A), such as by representing states as a dependency tree. For example, in case an interactive element includes two interactive pairs, each pair may be represented by a node, and connections between the pairs may be represented by nodes, thus reducing the number of duplicate information that is stored in the demo's repository and clarifying the editing effects.

In some exemplary embodiments, after editing an interactive element, the operator may be enabled to continue editing other interactive elements of the page, to edit other pages and respective interactive elements of the demo, to edit the base screen, or the like. In some exemplary embodiments, once the editing process is completed, such as in case that the operator does not wish to edit any other page or associated interactive elements of the demo, the data repository may be used to generate and publish the demo, e.g., according to Step 130.

On Step 130, a demonstration of the product may be generated, created, or the like, e.g., based on the data repository. In some exemplary embodiments, the demonstration may be generated based on one or more edited interactive elements, one or more non-edited interactive elements, or the like. In some exemplary embodiments, the demonstration may be generating by deploying a first page that was browser by the operator as an initial page of the demo, navigating between pages according to the recorded navigations of the operator, and activating functionalities of interactive elements according to the recorded interactive elements in the data repository.

In some exemplary embodiments, the demonstration may be provided to one or more end devices. For example, the operator may provide the demo to potential clients, present the demo in meetings with clients, or the like. In some exemplary embodiments, the demo may be published by making the demo accessible to be utilized by others. In some exemplary embodiments, the demo may be made available to end users using a local storage (e.g., copying the documents to a hard drive, using a disk-on-key, or the like), using a remote server (e.g., uploading the files to the server and providing access thereto), or the like. In some cases, the demo may be published by uploading the demo, or the respective repository, to a server, enabling remote access thereto. Additionally or alternatively, the demo may be published by downloading the demo, or the respective repository, to a storage device, enabling execution of the demo from the storage device. It is noted that the demo retained in the storage device may be operable in a standalone environment and without relying on access to any remote resource.

In some exemplary embodiments, the demonstration of the web-based product may be operable in a standalone environment and without relying on communications with any external server, at least since the demonstration may be detached from a backend of the web-based product, and may be absent of the client-side code of the product.

In some exemplary embodiments, after providing the demonstration to the end devices, the demonstration may be executed at the one or more end devices. For example, the executed code may comprise the edited interactive elements that replace the original interactive elements, code that comprises both the original interactive elements and the edited interactive elements with an indication that the edited interactive elements should be used, or the like. In some exemplary embodiments, the published demo may comprise an executable demo that launches a recorded page, and enables users to navigate through pages and interact with page elements according to the recorded interactive elements.

In some exemplary embodiments, executing the demonstration may comprise identifying triggers that appear in the one or more edited interactive elements, and replaying respective layout changes, without executing logic functionality of the web-based product. In some exemplary embodiments, in response to identifying a user of an end device performing a recorded user interaction with the page element, the demonstration may be configured to automatically perform the respective layout change. In some exemplary embodiments, during the execution of the demo, triggers may be identified and resulting layout changes may be performed iteratively, e.g., according to Steps 132 and 134. Steps 132 and 134 may be performed iteratively, while the demo is being executed.

On Step 132, a trigger may be identified in a page of the demo that is displayed to an end user. For example, a user interaction with the page may be detected, such as using the browser debugger, and a respective interactive element may be detected in the data repository. In some cases, the page may be rendered by the agent based on a recorded version of the page in the data repository. The agent may utilize one or more capturing tools, such as a browser debugger, to identify that the trigger was performed.

On Step 134, a responsive layout change may be executed. In some cases, the responsive layout change may be extracted from the respective interactive element, and executed in response to the user interaction, thereby replaying the layout change. In case of a sequence of interactive pairs, only the first interactive pair may be played in view of a first trigger, and a subsequent interactive pair may only be played in case that the second trigger was activated by the user. This may be performed iteratively, until the sequence is completed or until a next trigger of the sequence does not match a user interaction. In such cases, a different interactive element may be searched for in the database in which the trigger matches the user interaction.

Referring now to FIG. 2 illustrating an exemplary recordation process of an interactive element, in accordance with some exemplary embodiments of the disclosed subject matter.

As depicted in FIG. 2, an interactive element may be recorded by performing interactions between a Mutations Observer 210, a Target Page 220 of the product, a Debugger Manager 230, and a User 240. In some cases, Mutations Observer 210 and Debugger Manager 230 may be deployed by the agent, may be comprised in the agent, or the like.

For example, in order to record layout changes in Target Page 220, a mutation observer such as Mutations Observer 210 may be injected into Target Page 220. For example, Mutations Observer 210 may comprise a script of a browser extension, a browser debugger, or any other SDK or software that has access to layout changes of Target Page 220. In some cases, the DOM mutations may be collected from the observer function's scope. In some exemplary embodiments, this may be done via the Runtime API, which may allow to obtain properties from a specific object with a known ID.

In order to record triggers in Target Page 220, a Debugger Manager 230, such as a browser debugger or an event handler, may set event listener breakpoints within Target Page 220. For example, Debugger Manager 230 may set breakpoints for any user interactions, such as selecting a page element, hovering over an element, or the like, as well as for layout changes. In case User 240 interacts with an element in Target Page 220, such as by clicking on the element, a first breakpoint that was set by Debugger Manager 230 may be triggered. Event data from the associated event listener may be stored as a trigger of an interactive element.

In some cases, a layout of Target Page 220 may be changed in respond to User 240's interaction. One or more second breakpoints of Mutations Observer 210 may be triggered in response to the layout changes, and the layout changes, or indication thereof, may be stored in the interactive element. For example, the layout changes may be determined to be associated with the trigger of the first breakpoint, in case that a subsequent trigger of Debugger Manager 230 is detected after the layout changes. In some exemplary embodiments, the event data of the trigger may be joined with the DOM mutations, to thereby constitute an interactive element. In some exemplary embodiments, the interactive element may comprise all the information that is required in order to replay a specific event, such as various properties of the trigger and of the responsive layout changes.

By hitting the second breakpoints of Mutations Observer 210, the debugger event handler may be invoked due to the ‘other’ reason. When the reason for the debugger paused event is ‘other’, apart from getting the call frame, an asynchronous stack trace may be obtained. In some exemplary embodiments, the asynchronous stack trace may indicate all the functions that were called before generating a DOM mutation. In some exemplary embodiments, the call frame may be verified, to determine whether it actually originates from an observer function and that the event handler function that collected data before, is in the stack trace. If so, the mutations in this scope may be collected.

An exemplary embodiment of the disclosed subject matter is disclosed, without limiting the scope of the subject matter. An exemplary Mutations Observer 210 may be programed as follows:

```
function observer(records) {
  let now = Date.now( );
  const newRecords = records.map(mountRecordToSave);
  this.records = JSON.stringify(newRecords);
  debugger;
}
const mobs = new MutationObserver(observer.bind({ }));
mobs.observe(document.documentElement, {
  subtree: true,
  attributes: true,
  childList: true,
  characterData: false,
});
```

As can be appreciated, a breakpoint is hit every time any mutation happens in the “main world” (i.e., in Target Page 220). This may trigger the debugger with the specific reason being “Other”.

Debugger Manager 230 may comprise a debugger event handler, and may be programmed as follows:

```
chrome.debugger.onEvent.addListener(onEvent);
async function onEvent(debugee, name, obj, tabId) {
  if (name === “Debugger.paused”) {
    switch (obj.reason) {
      case “EventListener”:
        await saveEventData(debugee, obj);
        break;
      case “other”:
        if (checkStackTrace(obj)) {
          await collectMutations(debugee, obj, tabId);
        }
        break;
    }
    await sendCommandAsync(debugee, “Debugger.resume”, { });
  }
}
```

As can be appreciated, every time an “EventListener” breakpoint is hit, the event data is gathered and saved. Further, when the “Other” breakpoint is hit, probably due to a mutation, Debugger Manager 230 verifies that the event handler is in the stack trace, and if so, collects the mutations, mounts the interactive element and saves it. In addition, since the debugger is used to instrument the web-application, the code may be resumed after each breakpoint.

The checkStateTrack function may be configured to check the stack trace and collect the mutations, and may be programmed as follows:

```
export function checkStackTrace(obj) {
  if (!obj.asyncStackTrace) {
    console.log(“No stack trace found!”);
    return;
  }
  const asyncStackTrace = getAsyncStackTrace(obj);
  const firstFunction = getFirstFunctionInStackTrace(asyncStackTrace);
  const callerFunctionName = obj.callFrames[0].functionName;
  return callerFunctionName === “observer” &&
  !!eventMap.get(firstFunction);
}
```

The checkStateTrack function checks whether the caller function is the mutation observer function and whether the first function in the async stack trace is an event handler to which new event data can be added.

The collectMutations function may be configured to collect DOM mutations. To collect the mutations, the properties of the mutations may be obtained from the “this” local scope in the observer function, since the observed mutations may be stored therein. In some exemplary embodiments, this enables moving data in the debugger from a script running in Target Page 220 to another one in the background page of the extension.

```
export async function collectMutations(debugee, obj, tabId) {
  const { result } = await sendCommandAsync(debugee,
  “Runtime.getProperties”, {
    objectId: obj.callFrames[0].this.objectId,
    ownProperties: true,
  });
  const eventData = getEventDataFromStackTrace(obj);
  const mutations = JSON.parse(result.value);
  let tab = await getCurrentTabInfo(tabId);
  return createInteractiveEvent({
    type: eventData.type,
    target: eventData.target,
    url: tab.url,
    mutations,
  });
}
```

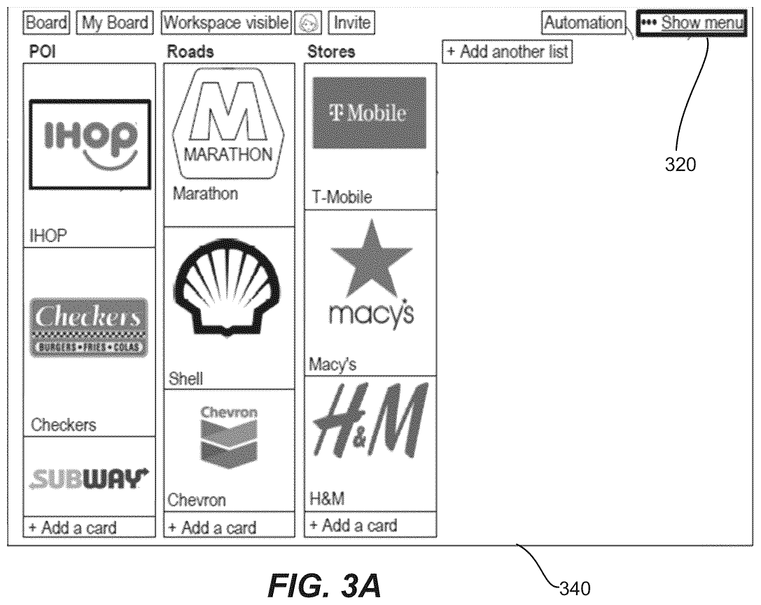

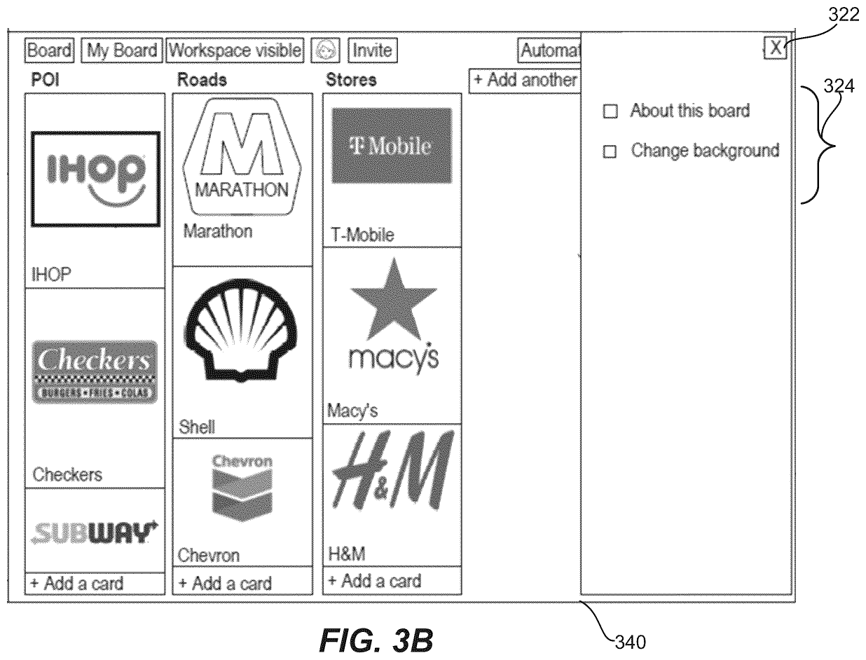

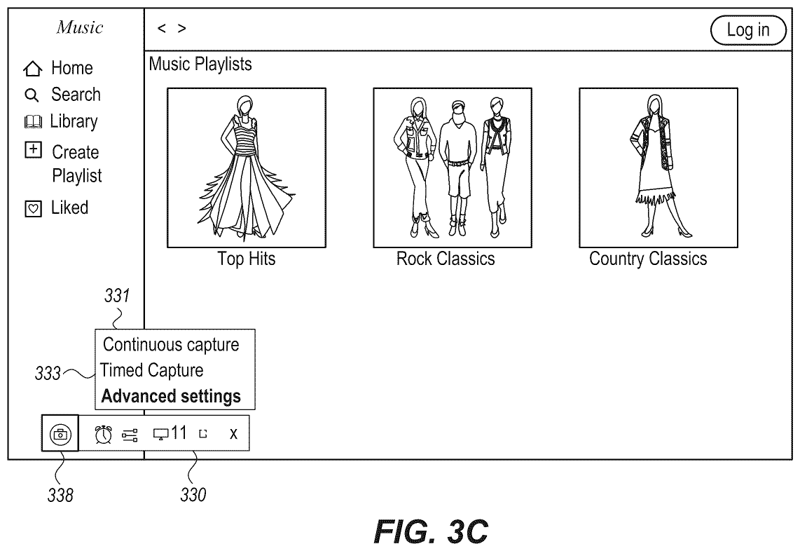

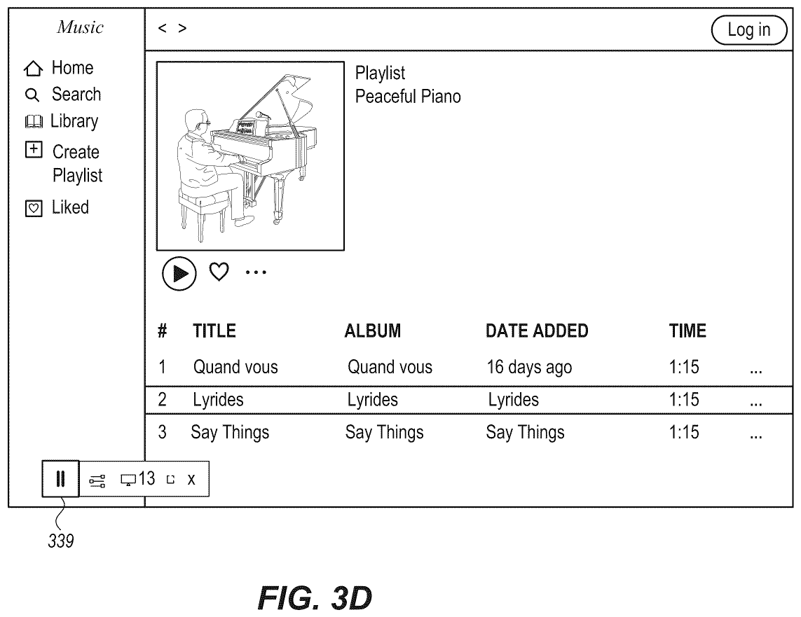

Referring now to FIGS. 3A-3C, illustrating an exemplary recordation process, in accordance with some exemplary embodiments of the disclosed subject matter.

During a recordation stage, an operator may perform one or more user interactions with a GUI of the page. For example, as depicted in FIG. 3A, an operator may capture a Screen 340, such as by launching Screen 340 in the product. The operator may then select an Element 320 of “show menu”, which may cause a Menu 324 to be launched with an Exit Element 322, e.g., as depicted in FIG. 3B. Such interactive functionality may be implemented by the web application itself using JavaScript code. A subsequent click event on the Exit Element 322 cause Menu 324 to be removed from Screen 340.

The agent may record the selection of Element 320 as a trigger, and the launching of Menu 324 with Exit Element 322 as a result of the trigger. For example, the agent may generate a record of an interactive element, that includes the selection of Element 320 as a trigger and the launching of Menu 324 as a resulting DOM mutation that introduces into Screen 340 a new element, Menu 324, which is shown in FIG. 3B.

In some cases, the subsequent selection of Exit Element 322 may depend of the previous selection of Element 320 (e.g., since Exit Element 322 was not presented prior thereto), and thus the interactive element may store a subsequent sequence of selecting Exit Element 322, resulting in a DOM mutation that removes Menu 324 from Screen 340. In other cases, separate interactive elements may be stored for any sequence of interactions. For example, a first interactive element may store the first trigger and response (the selection of Element 320), and a second interactive element may store the entire sequence that stems from the selection of Element 320. In other cases, every trigger and response may be kept separately, as a separate interactive element, and dependencies may be indicated by metadata, by a tree structure, or the like.

In some cases, some interactive elements may be retained in association with multiple product pages. For example, in case that the product comprises a website, and Menu 324 is included in multiple pages of the website (e.g., in all pages thereof), then interactive elements that includes interactions with Menu 324 may be determined to be activated for the multiple pages of the website. For example, such interactive elements may be copied to a storage of each page of the multiple pages, or a single interactive element may be stored with metadata indicating that the interactive element belongs to the multiple pages. Either way, the interactive element may appear in the editing stage for all of the multiple pages.

In order to initiate a recordation stage of a desired product, an operator may launch the software agent, such as by executing the agent, executing a demo-generating platform of the agent, or the like, while the product is executed. In some cases, as depicted in FIG. 3C, launching the software agent may cause a Widget 330, or any other toolbar, to appear over the product. For example, Widget 330 may comprise a Start Recording 338 button for starting recordation, a dynamically updated overall count of captured interactive elements, a dynamically updated count of captured interactive elements in a current page, a dynamically updated count of captured screens, a button for selecting a capturing mode (e.g., a continuous mode), a button for stopping the recording process, or the like.

After launching the software agent, the agent may select a capturing mode. For example, as depicted in FIG. 3C, the operator may select a Continuous Capturing Mode 331, in which all the interactions of the operator are automatically captured until terminating the recordation stage. In other cases, the operator may select a Timed Capturing Mode 333, in which certain interactions may be captured, such as three interactions, interaction in the next four seconds, or the like.

In case the operator wishes to pause the recording process, such as to perform one or more interactions with the product page that will not be included in the demo, the operator may instruct the recording to be paused, such as by selecting a Pause 339 button of Widget 330, as depicted in FIG. 3D. It is noted that in this example, the Pause 339 button is presented upon selecting Start Recording 338, instead of the Start Recording 338 button.

Referring now to FIGS. 4A-4B, illustrating an exemplary indirect editing stage, in accordance with some exemplary embodiments of the disclosed subject matter.

In some exemplary embodiments, after the recordation stage, the operator may edit the demo, e.g., according to FIGS. 4A-4B. For example, the operator may edit the DOM mutations of an interactive element, the trigger of an interactive element, the element on which the DOM mutation is implemented, the event that triggers the DOM mutation (e.g., type of event, the associated page element with which the trigger engaged, properties of the event, or the like), the base screen, or the like. For example, in case the trigger comprises hovering over a page element, the operator may be enabled to change the trigger to comprise selecting the page element, or to change the trigger to comprise hovering over a different page element.

FIG. 4A exemplifies a generation of a demo of a product. The demo includes Captured Screens 410 that were captured during the recording stage. One or more screens of Captured Screens 410 may be retained with associated captured interaction elements, such as Interaction States 420 which are associated with Screen 440. In order to edit any of the captured interactions, an element from Interaction States 420 may be selected by the operator, thus causing the element to be replayed, or presented, in Screen 440.

For example, as depicted in FIG. 4A, selecting the element Hover 452 from Interaction States 420, causes the element to be played, which causes the layout of Screen 440 to present a recorded user interaction of hovering over Element 462. For example, hovering over Element 462 may cause a visual presentation of Element 462 to change, such as by marking Element 462 with a lighter color than the background. In some exemplary embodiments, after playing Element 462, Element 462 may be edited, such as by changing a marking of Element 462 to have a different lighting or color, changing the associated text of Element 462 from “Continuous Capture” to another textual string, changing the “hover” interaction to another user interaction, such as a double click, or the like.

As another example, as depicted in FIG. 4B, selecting the Dropdown State 454 from Interaction States 420, causes Dropdown Element 464 to be played in its full position, which causes the layout of Screen 440 to present a recorded user interaction of selecting the Element 462. For example, selecting the Element 462 may cause the Dropdown Element 464 to be presented in the layout of Screen 440, as if a user selected Element 462. As another example, selecting the Element 462 may cause the Dropdown Element 464 to be presented and marked, as belonging to a same interactive element. In some exemplary embodiments, after playing Dropdown Element 464, Dropdown Element 464 may be edited, such as by changing the associated name of Dropdown Element 464 from “Continuous Capture” to another textual string, changing the text of the dropdown options (e.g., changing the dropdown string “More usability tests”), changing a font or color of the dropdown options, changing the “selection” interaction to another user interaction, or the like. It is noted that in case another element is edited, such as the “edit charts” element in Screen 440, properties of the element may be edited by modifying Screen 440, without creating a respective interactive element.

In some exemplary embodiments, in case that an interactive element comprises a sequence of user interactions, each pair, of trigger and respective DOM mutation, in the sequence may be updated individually. For example, an interactive element may comprise a first pair, in which a user hovers over Element 462, causing Element 462 to be marked in the layout, and a second subsequent pair, in which Element 462 is selected, causing Dropdown Element 464 to be presented. In such cases, Interaction States 420 may present each pair separately, to enable the operator to edit each desired pair.

Referring now to FIGS. 5A-5B, illustrating an exemplary direct editing stage, in accordance with some exemplary embodiments of the disclosed subject matter.

In contrast to FIGS. 4A-4B, in which interactive elements are edited by presenting and selecting such element, FIGS. 5A-5B depict a scenario in which interactive elements may be edited directly via the captured screen. As depicted in FIG. 5A, in order to edit a captured element, such as the Element 510 in Screen 540, an operator may edit Element 510 directly. For example, Element 510 may be edited directly by Element 510, clicking on Element 510, vocally commanding to edit Element 510, or the like.

In some cases, a selection of Element 510, such as a left click thereon, may cause an Open Interaction Element 520 to appear, or any other element that causes Element 510 to be in an editing mode. For example, a selection of Open Interaction Element 520 may cause the recorded selection of Element 510 to be played, such as causing Dropdown List 530 of FIG. 5B to be presented, marked as belonging to a same interactive element as Element 510, or the like. The operator may be enabled to edit features of Dropdown List 530. For example, the text of Dropdown List 530 may become editable, the format of Dropdown List 530 may become editable, or the like. In some cases, an editing toolbar, such as a screen editor, may be launched, or become visible, thus enabling to edit the respective element. In some cases, as depicted in FIG. 5B, after the operator finishes the edit of Dropdown List 530, the operator may close the edit mode of Element 510, such as by selecting Close Interaction Element 522. In other cases, the edit mode of Element 510 may be closed in any other way, such as by selecting another element of the page.

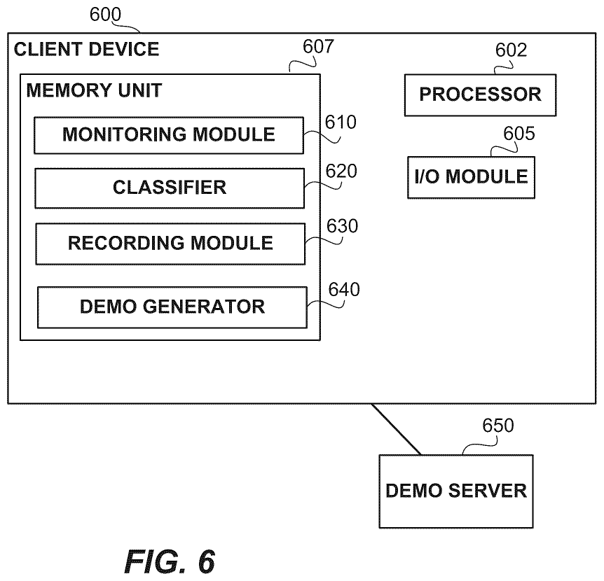

Referring now to FIG. 6 showing a block diagram of a system, in accordance with some exemplary embodiments of the disclosed subject matter.

In some exemplary embodiments, a Client Device 600 may comprise a Processor 602. Processor 602 may be a Central Processing Unit (CPU), a microprocessor, an electronic circuit, an Integrated Circuit (IC) or the like. Processor 602 may be utilized to perform computations required by Client Device 600 or any of its subcomponents.

In some exemplary embodiments of the disclosed subject matter, an Input/Output (I/O) Module 605 may be utilized to provide an output to and receive input from a user. I/O Module 605 may be used to transmit and receive information to and from the user or any other apparatus, e.g., Demo Server 650, a server of a web-based product, a communication network such as the Internet, or the like.

In some exemplary embodiments, Client device 600 may comprise a Memory Unit 607. Memory Unit 607 may be a short-term storage device or long-term storage device. Memory Unit 607 may be a persistent storage or volatile storage. Memory Unit 607 may be a disk drive, a Flash disk, a Random Access Memory (RAM), a memory chip, or the like. In some exemplary embodiments, Memory Unit 607 may retain program code operative to cause Processor 602 to perform acts associated with any of the subcomponents of Client Device 600.

In some exemplary embodiments, Memory Unit 607 may comprise a Monitoring Module 610 that is configured to monitor activities associated with a web-based product. For example, the web-based product may comprise a local desktop application that is stored within Memory Unit 607, a remote product that can be accessed by a web browser of Client Device 600 contacting a remote server, or the like. Monitoring module 610 may monitor user interactions with one or more pages of the web-based product, resulting layout changes, or DOM mutations, that result from the interactions, or the like.

Monitoring module 610 may monitor the activities using a browser extension, a debugger, a browser debugger, or the like. For example, in case the web-based product is rendered by a web browser, then a browser extension of the web browser may be enabled to monitor requests issued by the browser and responses thereto, and infer based thereon what events and changes are performed.

In some exemplary embodiments, Memory Unit 607 may comprise a Classifier 620, which may be configured to classify page activities monitored by Monitoring Module 610 to respective interactive elements that include a triggering user interaction, and a resulting layout change.

In some exemplary embodiments, Memory Unit 607 may comprise a Recording Module 630, which may be configured to record or store the interactive elements determined by Classifier 620. For example, the interactive elements may be stored locally in Memory Unit 607, in a server such as Demo Server 650, or the like. For example, Recording Module 630 may store the interactive elements in a client-side data repository that comprises information useful for implementing dynamic functionality on the captured pages of the web-based product. Recording Module 630 may store the interactive elements in a manner that enables to replay such elements. For example, Recording Module 630 may store event data associated with each trigger, and DOM changes associated with each layout change.

In some exemplary embodiments, Memory Unit 607 may comprise a Demonstration Generator 640, which may be configured to create a demo of the web-based product based on the stored interactive elements. For example, the demo may be generated to include shallow copies of the product, which include captured pages of the product and captured interactive elements of each page. In other cases, Demonstration Generator 640 may be external to Memory Unit 607, such as in Demo Server 650. For example, the stored interactive elements may be transmitted to Demo Server 650, which may generate based thereon a demo available for usage.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
generating a demonstration of a web-based product, said generating comprising:
recording one or more interactive elements, an interactive element of the one or more interactive elements comprises at least a trigger event and a layout change that results from the trigger event, the trigger event comprising a user interaction with a page element of the web-based product;
editing the one or more interactive elements, thereby generating one or more edited interactive elements, said editing comprises editing a feature of the interactive element; and
generating the demonstration based on the one or more edited interactive elements; and
providing the demonstration to one or more end devices, wherein, in response to identifying a user of an end device performing the user interaction with the page element, the demonstration is configured to automatically perform the layout change.

2. The method of claim 1, wherein the layout change comprises a Document Object Model (DOM) mutation.

3. The method of claim 1 further comprising recording a page of the web-based product that comprises the page element.

4. The method of claim 1, wherein, after said providing, the demonstration is executed at the one or more end devices, executing the demonstration comprises identifying trigger events that appear in the one or more edited interactive elements, and replaying respective layout changes, without executing logic functionality of the web-based product.

5. The method of claim 1, wherein the demonstration is detached from a backend of the web-based product, wherein the demonstration of the web-based product is operable in a standalone environment and without relying on communications with any external server.

6. The method of claim 1, wherein said editing the feature of the interactive element comprises one of:
modifying at least one text string displayed in a textual element of a page that comprises the page element;
modifying at least one color or font of an element in the page;
modifying the trigger event; and
modifying a visual property of the page element.

7. The method of claim 1, wherein said editing the one or more interactive elements enables customization of the demonstration for a potential client.

8. The method of claim 1, wherein said recording the one or more interactive elements comprises:
monitoring page events of the web-based product;
identifying in the page events the user interaction with the page element;
identifying in the page events the layout change;
determining that the user interaction triggered the layout change;
classifying the user interaction as the trigger event of the layout change; and
generating the interactive element to comprise the user interaction and the layout change.

9. The method of claim 8, wherein said monitoring is performed by a browser debugger.

10. An apparatus comprising a processor and coupled memory, the processor is adapted to:
generate a demonstration of a web-based product, said generate comprises:
recording one or more interactive elements, an interactive element of the one or more interactive elements comprises at least a trigger event and a layout change that results from the trigger event, the trigger event comprising a user interaction with a page element of the web-based product;
editing the one or more interactive elements, thereby generating one or more edited interactive elements, said editing comprises editing a feature of the interactive element; and
generating the demonstration based on the one or more edited interactive elements; and
provide the demonstration to one or more end devices, wherein, in response to identifying a user of an end device performing the user interaction with the page element, the demonstration is configured to automatically perform the layout change.

11. The apparatus of claim 10, wherein the layout change comprises a Document Object Model (DOM) mutation.

12. The apparatus of claim 10, wherein the processor is further adapted to record a page of the web-based product that comprises the page element.

13. The apparatus of claim 10, wherein, after said providing, the demonstration is executed at the one or more end devices, executing the demonstration comprises identifying trigger events that appear in the one or more edited interactive elements, and replaying respective layout changes, without executing logic functionality of the web-based product.

14. The apparatus of claim 10, wherein the demonstration is detached from a backend of the web-based product, wherein the demonstration of the web-based product is operable in a standalone environment and without relying on communications with any external server.

15. The apparatus of claim 10, wherein said editing the feature of the interactive element comprises one of:
modifying at least one text string displayed in a textual element of a page that comprises the page element;
modifying at least one color or font of an element in the page;
modifying the trigger event; and
modifying a visual property of the page element.

16. The apparatus of claim 10, wherein said editing the one or more interactive elements enables customization of the demonstration for a potential client.

17. The apparatus of claim 10, wherein said recording the one or more interactive elements comprises:
monitoring page events of the web-based product;
identifying in the page events the user interaction with the page element;
identifying in the page events the layout change;
determining that the user interaction triggered the layout change;
classifying the user interaction as the trigger event of the layout change; and
generating the interactive element to comprise the user interaction and the layout change.

18. The apparatus of claim 17, wherein said monitoring is performed by a browser debugger.

19. A computer program product comprising a non-transitory computer readable storage medium retaining program instructions, which program instructions, when read by a processor, cause the processor:
generate a demonstration of a web-based product, said generate comprises:
recording one or more interactive elements, an interactive element of the one or more interactive elements comprises at least a trigger event and a layout change that results from the trigger event, the trigger event comprising a user interaction with a page element of the web-based product;
editing the one or more interactive elements, thereby generating one or more edited interactive elements, said editing comprises editing a feature of the interactive element; and
generating the demonstration based on the one or more edited interactive elements; and
provide the demonstration to one or more end devices, wherein, in response to identifying a user of an end device performing the user interaction with the page element, the demonstration is configured to automatically perform the layout change.

20. The computer program product of claim 19, wherein, after said providing, the demonstration is executed at the one or more end devices, executing the demonstration comprises identifying trigger events that appear in the one or more edited interactive elements, and replaying respective layout changes, without executing logic functionality of the web-based product.
